(19) United States
(12) Patent Application Publication
(10) Pub. No.: US 2018/0285336 A1
(43) Pub. Date: Oct. 4, 2018

(54) Text Input Method, And Electronic Device

(71) Applicant: HUAWEI TECHNOLOGIES CO., LTD., Shenzhen, Guangdong (CN)

(72) Inventors: Pengfei GAO, Shenzhen (CN); Yue ZHANG, Nanjing (CN)

(21) Appl. No.: 15/762,930

(22) PCT Filed: Sep. 23, 2016
(86) PCT No.: PCT/CN2016/099879

§ 371 Date: Mar. 23, 2018

(30) Foreign Application Priority Data
Sep. 25, 2015 (CN) 201510623225.7

(51) Int. Cl. G06F 17/24; G06F 17/27; G06F 17/22

(52) U.S. Cl. CPC G06F 17/243; G06F 17/2223; G06F 17/2705

(57) ABSTRACT

The present disclosure relates to provide a text input method and an electronic device, where the method includes: obtaining characters entered by a user; parsing the characters to generate and display at least one group of candidate text corresponding to the characters; obtaining an operation performed on to-be-entered text by the user, where the to-be-entered text is any one of the at least one group of candidate text; determining, according to the obtained operation, an input location that is of the to-be-entered text in entered text and that is corresponding to the operation; and inserting the to-be-entered text in the input location.

This application claims priority to Chinese Patent Application No. 201510623225.7, filed with the Chinese Patent Office on Sep. 25, 2015 and entitled “TEXT INPUT METHOD, AND ELECTRONIC DEVICE”, which is incorporated herein by reference in its entirety.

### TECHNICAL FIELD

Embodiments of the present invention relate to the field of communications technologies, and in particular, to a text input method and an electronic device.

### BACKGROUND

With popularity of smartphones, a text input method acts as an important way for interaction between a user and a mobile phone, and a mobile phone use frequency and time length of the user also increase accordingly. An existing text input method is based on a manner of successively entering characters from left to right by means of linearity. A pinyin text input method is used as an example. The user successively enters English characters “shurufa”. The text input method receives a character stream, successively parses the “shu‘ru’ fa” from left to right, and generates a candidate word list “ [symbol] (input method), [symbol] (input), [symbol] (inpu), . . . ”. The user selects a candidate word “ [symbol] (input method)”, and the candidate word “ [symbol] (input method)” is filled at a right end of a control text box. A text input process is completed. In this example, the Chinese characters are used, the meaning of the Chinese characters is in the brackets following the Chinese characters.

However, when the user wants to insert some text in entered text in the text box, the user needs to manually adjust a cursor location to a to-be-inserted location. Some errors may occur in manual adjustment, and consequently, the user needs to adjust the cursor location for multiple times to an appropriate location, and text input efficiency and flexibility in the text input process decrease.

### SUMMARY

Embodiments of the present invention provide a text input method and an electronic device, so as to increase text input efficiency and flexibility in a text input process.

According to a first aspect, an embodiment of the present invention provides a text input method, including:

obtaining characters entered by a user;

parsing the characters to generate and display at least one group of candidate text corresponding to the characters;

obtaining an operation performed on to-be-entered text by the user, where the to-be-entered text is any one of the at least one group of candidate text;

determining, according to the obtained operation, an input location that is of the to-be-entered text in entered text and that is corresponding to the operation; and

inserting the to-be-entered text in the input location.

In a first possible implementation of the first aspect, before the determining, according to the obtained operation, an input location that is of the to-be-entered text in entered text and that is corresponding to the operation, the method further includes:

performing word segmentation processing on the entered text to obtain N groups of words, where N is an integer greater than or equal to 1; and

determining (N+1) to-be-entered locations of the to-be-entered text according to the N groups of words, where a location between every two groups of words is a to-be-entered location, a leftmost end of the entered text is a to-be-entered location, and a rightmost end of the entered text is a to-be-entered location; and

the determining, according to the obtained operation, an input location that is of the to-be-entered text in entered text and that is corresponding to the operation includes:

determining, according to the obtained operation, the input location in the (N+1) to-be-entered locations that is corresponding to the operation.

With reference to the first possible implementation of the first aspect, in a second possible implementation of the first aspect, the determining, according to the obtained operation, the input location in the (N+1) to-be-entered locations that is corresponding to the operation includes:

if the operation is an operation of pressing the to-be-entered text, and a time length of the operation of pressing the to-be-entered text is M preset time lengths, determining the (N+1−M)^{th} location counted from left to right in the entered text as the input location corresponding to the operation, where M is an integer greater than or equal to 1.

With reference to the first possible implementation of the first aspect, in a third possible implementation of the first aspect, the determining, according to the obtained operation, the input location in the (N+1) to-be-entered locations that is corresponding to the operation includes:

if the operation is an operation of tapping the to-be-entered text, determining the (N+1)^{th} location counted from left to right in the entered text as the input location corresponding to the operation.

With reference to the first possible implementation of the first aspect, in a fourth possible implementation of the first aspect, the determining, according to the obtained operation, the input location in the (N+1) to-be-entered locations that is corresponding to the operation includes:

if the operation is an operation of double tapping the to-be-entered text, determining the first location counted from left to right in the entered text as the input location corresponding to the operation.

According to a second aspect, an embodiment of the present invention provides an electronic device, where the electronic device includes:

an obtaining unit, configured to obtain characters entered by a user;

a processing unit, configured to parse the characters to obtain at least one group of candidate text corresponding to the characters;

a display unit, configured to display the at least one group of candidate text corresponding to the characters, where

the obtaining unit is further configured to obtain an operation performed on to-be-entered text by the user, where the to-be-entered text is any one of the at least one group of candidate text;

a determining unit, configured to determine, according to the obtained operation, an input location that is of the to-be-entered text in entered text and that is corresponding to the operation; and

an insertion unit, configured to insert the to-be-entered text in the input location.

In a first possible implementation of the second aspect, the processing unit is further configured to: before the determining unit determines, according to the obtained operation, the input location that is of the to-be-entered text in the entered text and that is corresponding to the operation, perform word segmentation processing on the entered text to obtain N groups of words, where N is an integer greater than or equal to 1; and determine (N+1) to-be-entered locations of the to-be-entered text according to the N groups of words, where a location between every two groups of words is a to-be-entered location, a leftmost end of the entered text is a to-be-entered location, and a rightmost end of the entered text is a to-be-entered location; and

the determining unit is specifically configured to determine, according to the obtained operation, the input location in the (N+1) to-be-entered locations that is corresponding to the operation.

With reference to the first possible implementation of the second aspect, in a second possible implementation of the second aspect, the determining unit is specifically configured to: if it is determined that the operation is an operation of pressing the to-be-entered text, and a time length of the operation of pressing the to-be-entered text is M preset time lengths, determine the (N+1−M)^{th} location counted from left to right in the entered text as the input location corresponding to the operation, where M is an integer greater than or equal to 1.

With reference to the first possible implementation of the second aspect, in a third possible implementation of the second aspect, the determining unit is specifically configured to: if it is determined that the operation is an operation of tapping the to-be-entered text, determine the (N+1)^{th} location counted from left to right in the entered text as the input location corresponding to the operation.

With reference to the first possible implementation of the second aspect, in a fourth possible implementation of the second aspect, the determining unit is specifically configured to: if it is determined that the operation is an operation of double tapping the to-be-entered text, determine the first location counted from left to right in the entered text as the input location corresponding to the operation.

According to the text input method and the electronic device provided in the embodiments, the electronic device obtains the operation performed on the to-be-entered text by the user, so as to determine the input location that is of the to-be-entered text in the entered text and that is corresponding to the operation; and then inserts the to-be-entered text in the determined input location, so that the user may accurately adjust the input location of the to-be-entered text, and text input efficiency and flexibility in a text input process increase.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following description show some embodiments of the present invention, and persons of ordinary skill in the art may still derive other drawings from these accompanying drawings without creative efforts.

FIG. 1 is a flowchart of Embodiment 1 of a text input method according to the present invention;

FIG. 2 is a flowchart of Embodiment 2 of a text input method according to the present invention;

FIG. 3 is a schematic structural diagram of Embodiment 1 of an electronic device according to the present invention; and

FIG. 4 is a schematic structural diagram of Embodiment 2 of an electronic device according to the present invention.

### DESCRIPTION OF EMBODIMENTS

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

In the following example, the Chinese characters are used, the meaning of the Chinese characters is in the brackets following the Chinese characters.

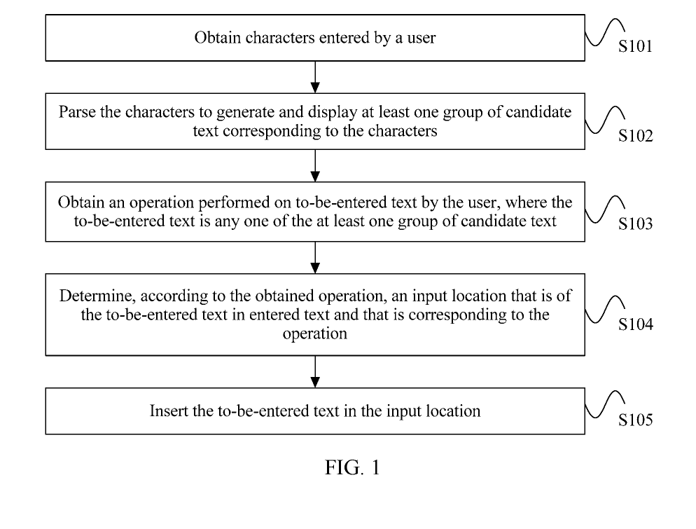

FIG. 1 is a flowchart of Embodiment 1 of a text input method according to the present invention. As shown in FIG. 1, the method in this embodiment may include the following steps.

S101. Obtain characters entered by a user.

In this embodiment, the method may be performed by an electronic device. The electronic device may be a smartphone, a tablet computer, or the like. The electronic device may obtain the characters entered by the user, and the characters are, for example, “where”.

S102. Parse the characters to generate and display at least one group of candidate text corresponding to the characters.

In this embodiment, after obtaining the characters entered by the user, the electronic device parses the obtained characters to generate the at least one group of candidate text corresponding to the characters, and displays the at least one group of candidate text corresponding to the characters. At least one group of candidate text corresponding to the characters “naer” includes, for example, “ [symbol] (where)”, “ [symbol] (there)”, “ [symbol] (whe)”, and “ [symbol] (wher)”.

S103. Obtain an operation performed on to-be-entered text by the user, where the to-be-entered text is any one of the at least one group of candidate text.

In this embodiment, the operation performed on the to-be-entered text by the user is obtained subsequently. The to-be-entered text may be any one of the at least one group of candidate text.

S104. Determine, according to the obtained operation, an input location that is of the to-be-entered text in entered text and that is corresponding to the operation.

In this embodiment, the electronic device may determine, according to the obtained operation performed on the to-be-entered text, an input location corresponding to the operation. The input location is the input location of the to-be-entered text in the entered text. In this embodiment, it may be preset that different operations are corresponding to different input locations. The entered text is, for example, text that is filled in a control text box and that is displayed on a screen of the electronic device.

S105. Insert the to-be-entered text in the input location.

In this embodiment, after determining the input location corresponding to the operation, the electronic device inserts the to-be-entered text in the input location. A text input process is completed.

According to the text input method provided in this embodiment, the operation performed on the to-be-entered text by the user is obtained, the input location that is of the to-be-entered text in the entered text and that is corresponding to the operation is determined, and then the to-be-entered text is inserted in the determined input location, so that the user may accurately adjust the input location of the to-be-entered text, and text input efficiency and flexibility in a text input process increase.

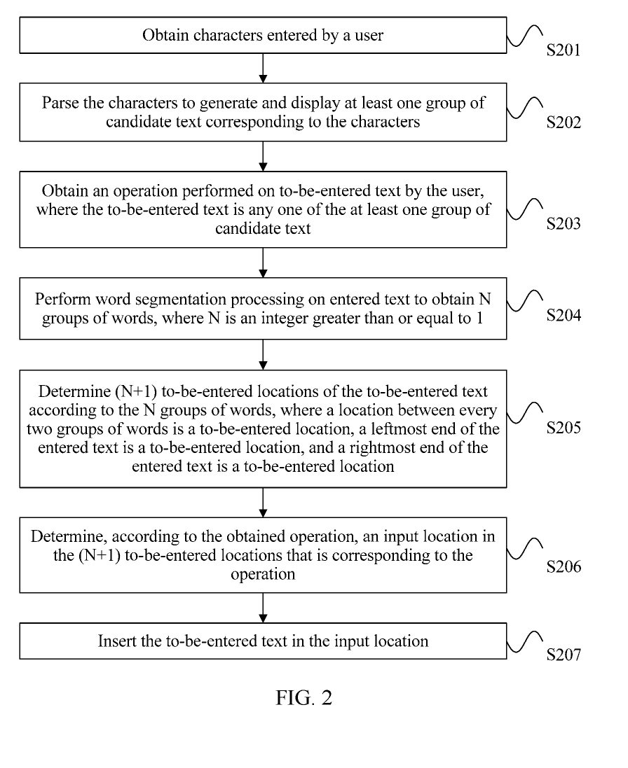

FIG. 2 is a flowchart of Embodiment 2 of a text input method according to the present invention. As shown in FIG. 2, the method in this embodiment may include the following steps.

S201. Obtain characters entered by a user.

S202. Parse the characters to generate and display at least one group of candidate text corresponding to the characters.

S203. Obtain an operation performed on to-be-entered text by the user, where the to-be-entered text is any one of the at least one group of candidate text.

In this embodiment, for a specific implementation process of S201 to S203, refer to related descriptions in method embodiment 1 of the present invention, and details are not described herein again.

S204. Perform word segmentation processing on entered text to obtain N groups of words, where N is an integer greater than or equal to 1.

In this embodiment, an electronic device may perform word segmentation processing on the entered text to obtain the N groups of words, where N is an integer greater than or equal to 1. It should be noted that, a word segmentation processing process is similar to that in the prior art, and details are not described herein again.

For example, the entered text is “ [symbol] (go to dinner tomorrow)”. Word segmentation processing is performed on the entered text “ [symbol] (go to dinner tomorrow)”, and three groups of words may be obtained. The three groups of words are “ [symbol] (tomorrow)”, “ [symbol] (go to)”, and “ [symbol] (dinner)”.

S205. Determine (N+1) to-be-entered locations of the to-be-entered text according to the N groups of words, where a location between every two groups of words is a to-be-entered location, a leftmost end of the entered text is a to-be-entered location, and a rightmost end of the entered text is a to-be-entered location.

In this embodiment, the electronic device may determine, according to the N groups of words obtained after the word segmentation processing, that the to-be-entered text has the (N+1) to-be-entered locations, where the location between every two groups of words is a to-be-entered location, the leftmost end of the entered text is a to-be-entered location, and the rightmost end of the entered text is a to-be-entered location. In addition, it should be noted that S203 and S204 to S205 are not performed in specific order.

For example, four to-be-entered locations may be determined in the three groups of words “ [symbol] (tomorrow)”, “ [symbol] (to)”, and “ [symbol] (dinner)” of the entered text “ [symbol] (go to dinner tomorrow)”. The four to-be-entered locations are: a to-be-entered location at a leftmost end of “ [symbol] (tomorrow)”, a to-be-entered location between “ [symbol] (tomorrow)” and “ [symbol] (go to)”, a to-be-entered location between “ [symbol] (go to)” and “ [symbol] (dinner)”, and a to-be-entered location at a rightmost end of “ [symbol] (dinner)”. Therefore, the four to-be-entered locations may be illustrated as follows: “to-be-entered location” [symbol] (tomorrow) “to-be-entered location” [symbol] (go to) “to-be-entered location” [symbol] (dinner) “to-be-entered location”.

S206. Determine, according to the obtained operation, an input location in the (N+1) to-be-entered locations that is corresponding to the operation.

S207. Insert the to-be-entered text in the input location.

In this embodiment, the electronic device determines the input location of the to-be-entered text from the (N+1) to-be-entered locations according to the obtained operation performed on the to-be-entered text by the user. For example, the to-be-entered text is “ [symbol] (where)”, and the electronic device determines, according to an operation performed on “ [symbol] (where)” by the user, that the to-be-entered location is between “ [symbol] (are you going to)” and “ [symbol] (eat)”. Then, the electronic device inserts “ [symbol] (where)” between “ [symbol] (are you going to)” and “ [symbol] (eat)”. For example, finally obtained text is: “ [symbol] (where are you going to eat tomorrow)”.

The following describes a specific implementation process of S206 with examples.

In a first feasible implementation, if the operation is an operation of pressing the to-be-entered text, and a time length of the operation of pressing the to-be-entered text is M preset time lengths, the (N+1−M)^{th} location counted from left to right in the entered text is determined as the input location corresponding to the operation, where M is an integer greater than or equal to 1.

Specifically, if the operation performed on the to-be-entered text by the user is a pressing operation, and a time length of the pressing operation is M preset time lengths, the (N+1−M)^{th} location counted from left to right in the entered text is determined as the input location of the to-be-entered text, where M is an integer greater than or equal to 1. For example, the entered text is “ [symbol] (go to dinner tomorrow)”. If the pressing operation performed on the input text by the user lasts one preset time length, the third location counted from left to right in “ [symbol] (go to dinner tomorrow)” may be determined as the input location of the to-be-entered text, that is, the input location of the to-be-entered text is a location between “ [symbol] (go) and “ [symbol] (dinner)”. For example, a process of determining the time length of the pressing operation may be: The electronic device obtains a time length in which pressure used by the user to continuously press the to-be-entered text exceeds preset pressure.

Optionally, in an implementation solution, the electronic device displays the following candidate text: [symbol] (where), [symbol] (there), [symbol] (whe), and [symbol] (wher). The user needs to enter text “ [symbol] where”, and then the user presses the to-be-entered text [symbol] (where)”. When a time length of pressing the to-be-entered text “ [symbol] (where)” is one preset time length, the electronic device moves a text input cursor “|” from a rightmost end of “ [symbol] (eat)” to a location between “ [symbol] (are you going to) and “ [symbol] (eat)”. That is, a location of the text input cursor is changed from “ [symbol] (tomorrow are you going to eat) |” to [symbol] (tomorrow are you going to) [symbol] (eat)”. In this case, if the location at which the text input cursor arrives is an input location in which the user wants to enter the text, the user no longer performs an operation of pressing “ [symbol] (where)”, and the electronic device may determine the location between “ [symbol] (are you going to)” and “ [symbol] (eat)” as the to-be-entered location. Alternatively, if the location of the text input cursor that is a location of “ [symbol] (tomorrow are you going to) [symbol] (eat)” is not an input location in which the user wants to enter the text, the user continues to press the to-be-entered text “ [symbol] (where)”. When a time length of continuously pressing the to-be-entered text “ [symbol] (where)” is two preset time lengths, the electronic device moves the text input cursor “ [symbol] ” from the location between “ [symbol] (are you going to)” and “ [symbol] (eat)” to a location between “ [symbol] (tomorrow)” and “ [symbol] (are you going to)”. That is, the location of the text input cursor is changed from “ [symbol] (tomorrow are you going to) [symbol] (eat)” to “ [symbol] (tomorrow) [symbol] (are you going to eat)”. In this case, if the location at which the text input cursor arrives is the input location in which the user wants to enter the text, the user no longer performs an operation of pressing “ [symbol] (where)”, and the electronic device may determine the location between “ [symbol] (tomorrow)” and “ [symbol] (are you going to)” as the to-be-entered location.

In a second feasible implementation, if the operation is an operation of tapping the to-be-entered text, the (N+1)^{th} location counted from left to right in the entered text is determined as the input location corresponding to the operation. The (N+1)^{th} location counted from left to right in the entered text is the location at the rightmost end of the entered text. The tapping operation is similar to a tapping operation in the prior art, and details are not described herein again. For example, an input location of “ [symbol] (where)” is the (N+1)^{th} location counted from left to right in the entered text “ [symbol] (are you going to eat tomorrow)”, and then “ [symbol] (are you going to eat tomorrow)” is obtained after “ [symbol] (where)” is inserted.

In a third feasible implementation, if the operation is an operation of double tapping the to-be-entered text, the first location counted from left to right in the entered text is determined as the input location corresponding to the operation. The first location counted from left to right in the entered text is the location at the leftmost end of the entered text. The double tapping operation is similar to a tapping operation in the prior art, and details are not described herein again. For example, an input location of “ [symbol] (where)” is the first location counted from left to right in the entered text “ [symbol] (are you going to eat)”, and then “ [symbol] (where are you going to eat)” is obtained after “ [symbol] (where)” is inserted.

According to the text input method provided in this embodiment, the operation performed on the to-be-entered text by the user is obtained, word segmentation processing is performed on the entered text to obtain the N groups of words, and the (N+1) to-be-entered locations of the to-be-entered text are determined according to the N groups of words. Then, the input location of the to-be-entered text in the (N+1) to-be-entered locations is determined according to the obtained operation, and the to-be-entered text is inserted in the input location, so that the user may accurately adjust the input location of the to-be-entered text, and text input efficiency and flexibility in a text input process increase.

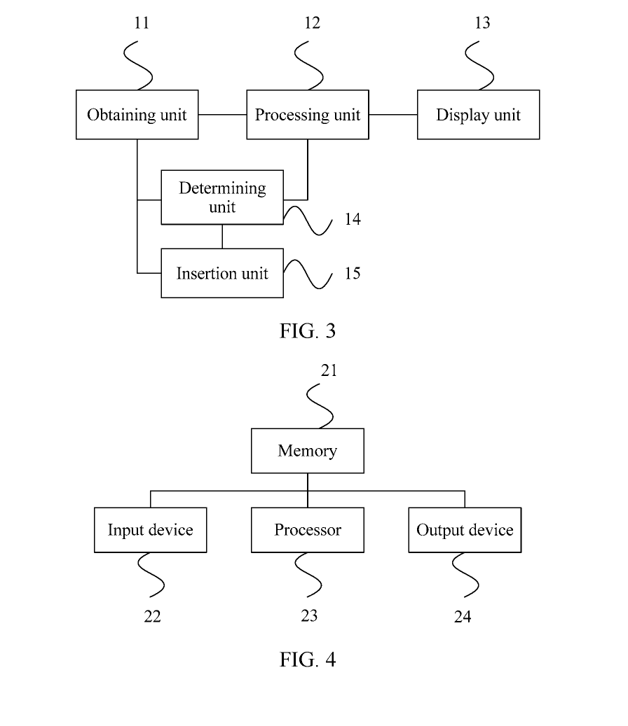

FIG. 3 is a schematic structural diagram of Embodiment 1 of an electronic apparatus according to the present invention. As shown in FIG. 3, the electronic apparatus in this embodiment may include: an obtaining unit 11, a processing unit 12, a display unit 13, a determining unit 14, and an insertion unit 15. The obtaining unit 11 is configured to obtain characters entered by a user. The processing unit 12 is configured to parse the characters to generate at least one group of candidate text corresponding to the characters. The display unit 13 is configured to display the at least one group of candidate text corresponding to the characters. The obtaining unit 11 is further configured to obtain an operation performed on to-be-entered text by the user, where the to-be-entered text is any one of the at least one group of candidate text. The determining unit 14 is configured to determine, according to the obtained operation, an input location that is of the to-be-entered text in entered text and that is corresponding to the operation. The insertion unit 15 is configured to insert the to-be-entered text in the input location.

Optionally, the processing unit 12 is further configured to: before the determining unit 14 determines, according to the obtained operation, the input location that is of the to-be-entered text in the entered text and that is corresponding to the operation, perform word segmentation processing on the entered text to obtain N groups of words, where N is an integer greater than or equal to 1; and determine (N+1) to-be-entered locations of the to-be-entered text according to the N groups of words, where a location between every two groups of words is a to-be-entered location, a leftmost end of the entered text is a to-be-entered location, and a rightmost end of the entered text is a to-be-entered location.

The determining unit 14 is specifically configured to determine, according to the obtained operation, the input location in the (N+1) to-be-entered locations that is corresponding to the operation.

Optionally, the determining unit 14 is specifically configured to: if it is determined that the operation is an operation of pressing the to-be-entered text, and a time length of the operation of pressing the to-be-entered text is M preset time lengths, determine the (N+1−M)^{th} location counted from left to right in the entered text as the input location corresponding to the operation, where M is an integer greater than or equal to 1.

Optionally, the determining unit 14 is specifically configured to: if it is determined that the operation is an operation of tapping the to-be-entered text, determine the (N+1)^{th} location counted from left to right in the entered text as the input location corresponding to the operation.

Optionally, the determining unit 14 is specifically configured to: if it is determined that the operation is an operation of double tapping the to-be-entered text, determine the first location counted from left to right in the entered text as the input location corresponding to the operation.

The electronic apparatus in this embodiment may be configured to execute the technical solution in each method embodiment of the present invention, and implementation principles and technical effects of the electronic apparatus are similar, and details are not described herein again.

FIG. 4 is a schematic structural diagram of Embodiment 2 of an electronic device according to the present invention. In this embodiment of the present invention, the electronic device may be a computer system in a handheld form, such as a smartphone, a tablet personal computer (Tablet Personal Computer), a personal digital assistant (personal digital assistant, PDA for short), a mobile Internet device (Mobile Internet Device, MID for short), a wearable device (Wearable Device), or the like. Persons skilled in the art may understand that a structure of the electronic device shown in FIG. 4 does not constitute any limitation to the electronic device, and the electronic device may include components more or fewer than those shown in FIG. 4, or a combination of some components, or components disposed differently. The following describes each constituent component of the electronic device in detail with reference to FIG. 4.

An input device 22 is configured to implement interaction between a user and the electronic device, and/or enter information to the electronic device. For example, the input device 22 may receive digit or character information that is entered by the user, so as to generate signal input related to user settings or function control. In a specific implementation of the present invention, the input device 22 may be a touch panel, or may be another man-machine interface, such as a substantive input key or a microphone; or may be another apparatus for obtaining external information, such as a camera. The touch panel, which is also referred to as a touchscreen or a touchscreen, may collect an operation action of touching or approaching performed by the user on the touch panel, for example, an operation action performed by the user on the touch panel or at a position close to the touch panel by using any proper object or accessory such as a finger or a stylus, and a corresponding connected apparatus is driven according to a preset program. Optionally, the touch panel may include two parts: a touch detection apparatus and a touch controller. The touch detection apparatus detects a touch operation of the user, converts the detected touch operation into an electrical signal, and transmits the electrical signal to the touch controller. The touch controller receives the electrical signal from the touch detection apparatus, converts the electrical signal into touch point coordinates, and then transmits the touch point coordinates to the processor 23. The touch controller may further receive and execute a command sent by the processor 23. In addition, the touch panel may be implemented by using multiple types such as a resistive type, a capacitive type, an infrared (Infrared), and a surface acoustic wave. In another implementation of the present invention, the substantive input key used by the input device 22 may include but is not limited to one or more of a physical keyboard, a functional button (such as a volume control button or a power button), a trackball, a mouse, a joystick, or the like. An input device in a form of a microphone may collect voice that is input by the user or an environment, and convert the voice into a command that is in a form of an electrical signal and that may be executed by the processor 23. In some implementations of the present invention, the input device 22 may also be sensing components in various types, for example, a Hall component, which is configured to detect a physical quantity of the electronic device, for example, a force, a torque, pressure, a stress, a position, a displacement, a speed, acceleration, an angle, an angular velocity, a quantity of revolutions, a rotational speed, and a time at which a working status changes, and convert the physical quantity into an electric quantity for detection and control. Other sensing components may further include a gravity sensor, a tri-axis accelerometer, a gyroscope, and the like.

An output device 24 includes but is not limited to an image output device and a sound output device. The image output device is configured to output text, a picture, and/or a video. The image output device may include a display panel, for example, a display panel configured in a form of a liquid crystal display (Liquid Crystal Display, LCD for short), an organic light-emitting diode (Organic Light-Emitting Diode, OLED for short), a field emission display (field emission display, FED for short), and the like; or the image output device may include a reflective display, for example, an electrophoretic (electrophoretic) display or a display using an interferometric modulation of light (Interferometric Modulation of Light) technology. The image output device may include a single display or multiple displays in different sizes. In a specific implementation of the present invention, the touch panel used by the input device 22 may also be used as a display panel of the output device. For example, after detecting a gesture of touching the touch panel or approaching the touch panel, the touch panel transmits the gesture to the processor 23 to determine a type of a touch event, and then the processor 23 provides corresponding visual output on the display panel according to the type of the touch event. The input device 22 and the output device 24 are used as two independent components to implement input and output functions of the electronic device, but the touch panel and the display panel may be integrated to implement the input and output functions of the electronic device. For example, the image output device may display various graphical user interfaces (Graphical User Interface, GUI for short), so as to use the graphical user interfaces as virtual control components, and the graphical user interfaces include but are not limited to a window, a scrollbar, an icon, and a scrapbook, so that the user operates in a touch manner.

The processor 23 is a control center of the electronic device, and connects to all parts of an entire computer by using various interfaces and lines. The processor 23 executes various functions of a station and processes data by running or executing a software program and/or an application unit stored in the memory and invoking data stored in the memory 21, so as to perform overall monitoring on the station.

As shown in FIG. 4, the electronic device may include the memory 21, the input device 22, the processor 23, and the output device 24. The memory 21 is configured to store program code of performing a text input method. The memory 21 may include a nonvolatile memory (Non-volatile Memory). The input device 22 may be a touchscreen, and the output device 24 may also be a touchscreen. The processor 23 may be a central processing unit (Central Processing Unit, CPU for short), or an application-specific integrated circuit (Application Specific Integrated Circuit, ASIC for short), or one or more integrated circuits configured to implement the embodiments of the present invention. The input device 22, the processor 23, and the output device 24 are configured to invoke the program code stored in the memory 21 to execute the following operations.

The input device 22 is configured to obtain characters entered by a user.

The processor 23 is configured to parse the characters to generate at least one group of candidate text corresponding to the characters.

The output device 24 is configured to display the at least one group of candidate text corresponding to the characters.

The processor 23 is further configured to: obtain an operation performed on to-be-entered text by the user, where the to-be-entered text is any one of the at least one group of candidate text; determine, according to the obtained operation, an input location that is of the to-be-entered text in entered text and that is corresponding to the operation; and insert the to-be-entered text in the input location.

Optionally, the processor 23 is further configured to: before determining, according to the obtained operation, the input location that is of the to-be-entered text in the entered text and that is corresponding to the operation, perform word segmentation processing on the entered text to obtain N groups of words, where N is an integer greater than or equal to 1; and determine (N+1) to-be-entered locations of the to-be-entered text according to the N groups of words, where a location between every two groups of words is a to-be-entered location, a leftmost end of the entered text is a to-be-entered location, and a rightmost end of the entered text is a to-be-entered location.

When determining, according to the obtained operation, the input location that is of the to-be-entered text in the entered text and that is corresponding to the operation, the processor 23 is specifically configured to determine, according to the obtained operation, the input location in the (N+1) to-be-entered locations that is corresponding to the operation.

Optionally, in a first feasible implementation, when determining, according to the obtained operation, the input location in the (N+1) to-be-entered locations that is corresponding to the operation, the processor 23 is specifically configured to: if the operation is an operation of pressing the to-be-entered text, and a time length of the operation of pressing the to-be-entered text is M preset time lengths, determine the (N+1−M)^{th} location counted from left to right in the entered text as the input location corresponding to the operation, where M is an integer greater than or equal to 1.

In a second feasible implementation, when determining, according to the obtained operation, the input location in the (N+1) to-be-entered locations that is corresponding to the operation, the processor 23 is specifically configured to: if the operation is an operation of tapping the to-be-entered text, determine the (N+1)^{th} location counted from left to right in the entered text as the input location corresponding to the operation.

In a third feasible implementation, when determining, according to the obtained operation, the input location in the (N+1) to-be-entered locations that is corresponding to the operation, the processor 23 is specifically configured to: if the operation is an operation of double tapping the to-be-entered text, determine the first location counted from left to right in the entered text as the input location corresponding to the operation.

It should be noted that, for a specific implementation technical solution of invoking the program code stored in the memory 21 by the input device 22, the processor 23, and the output device 24, refer to the text input methods provided in the foregoing embodiments of the present invention, and implementation principles and technical effects of the technical solution are similar. For details, refer to related records in the foregoing embodiments, and details are not described herein again.

Persons of ordinary skill in the art may understand that all or some of the steps of the method embodiments may be implemented by a program instructing relevant hardware. The program may be stored in a computer-readable storage medium.

When the program runs, the steps of the method embodiments are performed. The foregoing storage medium includes: any medium that can store program code, such as a read-only memory (English: Read-Only Memory, ROM for short), a random access memory (English: Random Access Memory, RAM for short), a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

1. A text input method, comprising:
obtaining characters entered by a user;
parsing the characters to generate and display at least one group of candidate text corresponding to the characters;
obtaining one of a plurality of possible operations performed on to-be-entered text by the user, wherein the to-be-entered text is any one of the at least one group of candidate text;
determining, according to the obtained operation, an input location of the to-be-entered text in entered text and corresponding to the obtained operation, wherein the input location is changed based on each possible operation; and
inserting the to-be-entered text in the input location.

2. The method according to claim 1, wherein before the determining, according to the obtained operation, an input location of the to-be-entered text in entered text and corresponding to the obtained operation, the method further comprises:
performing word segmentation processing on the entered text to obtain N groups of words, wherein N is an integer greater than or equal to 1; and
determining (N+1) to-be-entered locations of the to-be-entered text according to the N groups of words, wherein a location between every two groups of words is a to-be-entered location, a left-most end of the entered text is a to-be-entered location, and a right-most end of the entered text is a to-be-entered location; and
wherein the determining, according to the obtained operation, an input location of the to-be-entered text in entered text and corresponding to the obtained operation comprises:
determining, according to the obtained operation, the input location in the (N+1) to-be-entered locations corresponding to the obtained operation.

3. The method according to claim 2, wherein the determining, according to the obtained operation, the input location in the (N+1) to-be-entered locations corresponding to the obtained operation comprises:
if the obtained operation is an operation of pressing the to-be-entered text, and a time length of the obtained operation of pressing the to-be-entered text is M preset time lengths, determining an (N+1−M)^{th} location counted from left to right in the entered text as the input location corresponding to the obtained operation, wherein M is an integer greater than or equal to 1.

4. The method according to claim 2, wherein the determining, according to the obtained operation, the input location in the (N+1) to-be-entered locations corresponding to the obtained operation comprises:
if the obtained operation is an operation of tapping the to-be-entered text, determining an (N+1)^{th} location counted from left to right in the entered text as the input location corresponding to the obtained operation.

5. The method according to claim 2, wherein the determining, according to the obtained operation, the input location in the (N+1) to-be-entered locations corresponding to the obtained operation comprises:
if the obtained operation is an operation of double tapping the to-be-entered text, determining a first location counted from left to right in the entered text as the input location corresponding to the obtained operation.

6-10. (canceled)

11. An electronic device comprising a memory, an input device, and at least one processor coupled with the memory, wherein
the input device is configured to obtain characters entered by a user;
the at least one processor reads an instruction stored in the memory, wherein the at least one processor is configured:
parse the characters to generate and display at least one group of candidate text corresponding to the characters;
obtain one of a plurality of possible operations performed on to-be-entered text by the user, wherein the to-be-entered text is any one of the at least one group of candidate text;
determine, according to the obtained operation, an input location of the to-be-entered text in entered text and corresponding to the obtained operation, wherein the input location is changed based on each possible operation; and
insert the to-be-entered text in the input location.

12. The electronic device according to claim 11, wherein before the determining, according to the obtained operation, an input location of the to-be-entered text in entered text and corresponding to the obtained operation, the at least one processor is further configured to:
perform word segmentation processing on the entered text to obtain N groups of words, wherein N is an integer greater than or equal to 1; and
determine (N+1) to-be-entered locations of the to-be-entered text according to the N groups of words, wherein a location between every two groups of words is a to-be-entered location, a left-most end of the entered text is a to-be-entered location, and a right-most end of the entered text is a to-be-entered location; and
wherein the determining, according to the obtained operation, an input location of the to-be-entered text in entered text and corresponding to the obtained operation comprises:
determining, according to the obtained operation, the input location in the (N+1) to-be-entered locations corresponding to the obtained operation.

13. The electronic device according to claim 12, wherein the determining, according to the obtained operation, the input location in the (N+1) to-be-entered locations corresponding to the obtained operation comprises:
if the obtained operation is an operation of pressing the to-be-entered text, and a time length of the obtained operation of pressing the to-be-entered text is M preset time lengths, determining an (N+1−M)^{th} location counted from left to right in the entered text as the input location corresponding to the obtained operation, wherein M is an integer greater than or equal to 1.

14. The electronic device according to claim 12, wherein the determining, according to the obtained operation, the input location in the (N+1) to-be-entered locations corresponding to the obtained operation comprises:
if the obtained operation is an operation of tapping the to-be-entered text, determining an (N+1)^{th} location counted from left to right in the entered text as the input location corresponding to the obtained operation.

15. The electronic device according to claim 12, wherein the determining, according to the obtained operation, the input location in the (N+1) to-be-entered locations that is corresponding to the obtained operation comprises:
if the obtained operation is an operation of double tapping the to-be-entered text, determining a first location counted from left to right in the entered text as the input location corresponding to the obtained operation.

16. A computer program product comprising a non-transitory computer-readable medium storing computer executable instructions that, when executed by at least one processor, instruct the at least one processor to:
obtain characters entered by a user;
parse the characters to generate and display at least one group of candidate text corresponding to the characters;
obtain one of a plurality of possible operations performed on to-be-entered text by the user, wherein the to-be-entered text is any one of the at least one group of candidate text;
determine, according to the obtained operation, an input location of the to-be-entered text in entered text and corresponding to the obtained operation, wherein the input location is changed based on each possible operation; and
insert the to-be-entered text in the input location.

17. The computer program product according to claim 16, wherein before the determining, according to the obtained operation, an input location of the to-be-entered text in entered text and corresponding to the obtained operation, comprises:
performing word segmentation processing on the entered text to obtain N groups of words, wherein N is an integer greater than or equal to 1; and
determining (N+1) to-be-entered locations of the to-be-entered text according to the N groups of words, wherein a location between every two groups of words is a to-be-entered location, a leftmost end of the entered text is a to-be-entered location, and a rightmost end of the entered text is a to-be-entered location; and
the determining, according to the obtained operation, an input location of the to-be-entered text in entered text and corresponding to the obtained operation comprises:
determining, according to the obtained operation, the input location in the (N+1) to-be-entered locations corresponding to the obtained operation.

18. The computer program product according to claim 17, wherein the determining, according to the obtained operation, the input location in the (N+1) to-be-entered locations corresponding to the obtained operation comprises:
if the obtained operation is an operation of pressing the to-be-entered text, and a time length of the obtained operation of pressing the to-be-entered text is M preset time lengths, determining an (N+1−M)^{th} location counted from left to right in the entered text as the input location corresponding to the obtained operation, wherein M is an integer greater than or equal to 1.

19. The computer program product according to claim 17, wherein the determining, according to the obtained operation, the input location in the (N+1) to-be-entered locations corresponding to the obtained operation comprises:
if the obtained operation is an operation of tapping the to-be-entered text, determining an (N+1)^{th} location counted from left to right in the entered text as the input location corresponding to the obtained operation.

20. The computer program product according to claim 17, wherein the determining, according to the obtained operation, the input location in the (N+1) to-be-entered locations corresponding to the obtained operation comprises:
if the obtained operation is an operation of double tapping the to-be-entered text, determining a first location counted from left to right in the entered text as the input location corresponding to the obtained operation.
